(19) United States
(12) Patent Application Publication
(10) Pub. No.: US 2023/0312996 A1
(43) Pub. Date: Oct. 5, 2023

(54) Filmic release base material with improved silicone anchorage properties

(71) Applicant: UPM-Kymmene Corporation, Helsinki (FI)

(72) Inventors: Jaakko RAUTALAHTI, Tampere (FI); Harri KOSONEN, Lappeenranta (FI); Kuisma LITTUNEN, Lappeenranta (FI)

(21) Appl. No.: 18/024,534

(22) PCT Filed: Sep. 17, 2020
(86) PCT No.: PCT/FI2020/050598

§ 371 Date: Mar. 3, 2023

(51) Int. Cl. C09J 7/40; B29C 48/00; B29C 48/21

(52) U.S. Cl. CPC C09J 7/401; B29C 48/022; B29C 48/21; B29K 2029/04

(57) ABSTRACT

The application relates to a polymeric film (FILM 1) for a release liner (REL2), comprising a polymeric support layer (S1) of a first composition comprising one or more polyolefins and/or polyesters, and an extruded primer layer (PRIM1) of a second composition comprising a thermoplastic polymer covalently bounded to functional vinyl groups.

### TECHNICAL FIELD

The present application relates to polymeric films for release liners. The present application further relates to methods for manufacturing a polymeric film for a release liner.

### BACKGROUND

A release liner is a paper or plastic/polymeric-based film sheet used to prevent a sticky surface from prematurely adhering. Typical release liners in pressure-sensitive laminates or other materials, such as tapes, are based either on cellulosic or filmic (polymeric) substrates, which are the carrier materials of the release agent. A commonly used release agent for release liners is crosslinkable silicone. These substrates are silicone coated in order to achieve desired release values for various face materials containing adhesive.

Well performing silicone network must be able to smoothly release any coated adhesive layer but it must also adhere well onto the carrier substrate. This anchorage is typically achieved with weak interactions, such as hydrogen bonding. In order to achieve any level of hydrogen bonding, substrate material must have some polar groups on its surface. Due to the different properties of cellulosic and filmic substrates, the anchorage of silicone to the surface of these substrates is also achieved differently. Filmic substrates are most commonly corona-treated, in order to modify their surface energy to improve silicone anchorage. Corona treatment is a process by which an electrical discharge is used to raise the critical surface tension of filmic materials to improve the adhesion of coatings, adhesives, ink, etc. to the substrate.

However, extremely high corona treatment of a plastic film can cause polymer chain scission or pinholes on the film surface, which can cause anchorage problems. Further, the anchorage that is purely based on weak interactions tends to be rather unstable over longer period of time, causing issues with silicone transfer and loss of specific release properties.

### SUMMARY

The present application represents a new approach to provide polymeric films for release liners with improved properties and to simplify the steps as well as the chemicals involved in the manufacturing process thereof.

In one aspect, the present application provides a polymeric film for a release liner, comprising
a polymeric support layer of a first composition comprising one or more polyolefins and/or polyesters, and
an extruded primer layer of a second composition comprising a thermoplastic polymer covalently bonded to functional vinyl groups.

Thus, the extruded primer layer comprises the functional vinyl groups.

Preferably, said thermoplastic polymer covalently bounded to functional vinyl groups has been obtained from a reaction product of a molten thermoplastic and a grafting agent containing functional vinyl groups. This is beneficial because the reaction product is a solid substance that does not require any processing before further melt processing. Moreover, the modification can also be done online in the film extruder.

Optionally, the polymeric film may further comprise a tie layer, which is situated between the polymeric support layer and the extruded primer layer.

The extruded primer layers according to the present application have several effects, as to be explained below.

The extruded primer layer according to the present application, on one hand, has excellent adhesion to the underlying polymeric support layer, as the thermoplastic melt sticks firmly to the polymeric support layer after solidifying, when adjacent polymer compositions, i.e. the first composition and the second composition, have similar polarity or covalent bonds at their interface. On the other hand, the extruded primer layer, which comprises functional vinyl groups as the extruded primer layer comprises the second composition of a thermoplastic polymer covalently bonded to functional vinyl groups, provides an excellent foundation for siliconization, as the functional vinyl groups in the structure of the thermoplastic polymer, which are present in the extruded primer layer, are able to form covalent bonds with an addition curing silicone, when forming a release liner of the polymeric film that contains the extruded primer layer. Therefore, the silicone anchorage is significant improved.

The extruded primer layer according to the present application contributes an improved coverage of surface for subsequent silicone coating, which in turns improves the consistency of the release value. A high quality silicone coating requires good coverage of the substrate. Pinholes in the solvent-based or aqueous-dispersion-based primer layer may lead to areas of silicone coating with poor anchorage and silicone rub-off, resulting in poor release stability over time. Pinholes are a coating defect, pore-like penetrations present on a coating. They may appear in solvent-based coatings due to the entrapment of moisture, air, solvents or other fluids in the coating solution. Pinholes on transparent films can be studied and quantified by optical microscopy. The number of pinholes on the surface of the extruded primer layers according to the present application has been significantly decreased, as the primer layer composition for the extruded primer layer does not contain water or solvent, and thus entrapping moisture or volatile solvent is avoided. Further, as there are less holes to be filled with the silicone coating, the polymeric film according to the present application can be siliconized with a less silicone coat weight, as compared with a primer layer wherein the aqueous-dispersion- or solvent-based coating is used. Thus, cost-efficiency of preparing silicone coating can be improved.

In another aspect, the present application provides a method for manufacturing a polymeric film for a release liner, said method comprising
extruding a molten first composition comprising one or more polyolefins and/or polyesters, thereby obtaining an extruded first composition,
extruding a molten second composition comprising a thermoplastic polymer covalently bonded to functional vinyl groups, thereby obtaining an extruded second composition; thus, the extruded primer layer comprises the functional vinyl groups,
allowing the temperature of the extruded molten first composition to decrease below its melting point, thereby forming a polymeric support layer,
allowing the temperature of the extruded molten second composition to decrease below its melting point, thereby forming an extruded primer layer, and
forming the polymeric film comprising the polymeric support layer and the extruded primer layer.

Preferably, the method may further comprise
extruding a third composition comprising a compatibilizer, thereby obtaining an extruded third composition, and
allowing the temperature of the extruded molten third composition to decrease below its melting point, thereby forming a tie layer,
   such that the tie layer is situated between the polymeric support layer and the extruded primer layer.

According to the methods of the present application, at least two of the above-mentioned molten compositions may be co-extruded. For example, the first composition and the second composition may be co-extruded. For example, the first composition, the second composition and the third composition may be co-extruded.

In the method according to the present application, extruding a molten second composition comprising at least one thermoplastic polymer covalently bounded to functional vinyl groups has several effects, as to be explained below.

Corona treatment forms hydroxyl, carboxyl, and free radical groups. As these reactive moieties react further quickly and in an uncontrollable manner, in-line corona treatment is recommended even on high level pre-treated substrates. Therefore, the corona-treated films shall be subject to silicone coating as soon as possible. Filamentary corona discharges can also create pinholes in the polymer coating layer, making the surface less suitable for siliconization.

In the method according to the present application, on the contrary, extruding a molten second composition comprising at least one thermoplastic polymer covalently bounded to functional vinyl groups contributes the polymeric film a stable surface for subsequent silicone coating. The surface of the extruded primer layer is chemically stable until the silicone coating is applied on top of it and reacting with it, and after curing a stable release liner is formed. This provides a great flexibility in the arrangement of production line in the industry.

According to the present method, during the manufacturing of the polymeric film, volatile organic compounds are reduced or eliminated, and the drying or curing step is eliminated. The harmful chemicals are reduced, and the manufacturing steps are a lot simplified. Further, the polymeric film according to the present application has a predictable thickness, as the extruded primer layer does not lose thickness during solidifying, while solvent-based primer layer composition may lose up to 50-70% of layer thickness during drying. Therefore, the guaranteed properties and quality of the polymeric films produced in the industrial scale can be better managed.

The main embodiments are characterized in the independent claims. Various embodiments are disclosed in the dependent claims. The embodiments and examples recited in the claims and in the specification are mutually freely combinable unless otherwise explicitly stated.

### BRIEF DESCRIPTION OF THE DRAWINGS

FIG. 1 shows a schematic drawing, by way of an example, of a cross-dimensional view of a release liner REL1 comprising a polymeric film FILM1 and a release layer, i.e. a silicone coating layer SIL1;

FIG. 2 shows a schematic drawing of a cross-dimensional view of another example of release liner comprising a polymeric film FILM1 and a release layer, i.e. a silicone coating layer SIL1;

FIG. 3 illustrates, by way of examples, a general formula and some variations of an organic acid anhydride having at least one acyl group which has a catenated carbon structure of at least 4 carbon atoms and which ends into a vinyl group, which are suitable for use as a reagent in a method for manufacturing thermoplastic poly(vinyl alcohol) derivative by a melt state reaction;

FIG. 4 illustrates, by way of an example, an ester bond forming condensation reaction between an organic acid anhydride and thermoplastic poly(vinyl alcohol) in a melt state, wherein at least some of the organic acid anhydride reacts with the hydroxyl groups of the thermoplastic poly(vinyl alcohol) in an ester bond forming condensation reaction, such that reaction product is formed which contains carboxylic acid residue and thermoplastic poly(vinyl alcohol) derivative, wherein at least some of said carboxylic acid residue contains chains which end into vinyl groups, and at least some of the ester bonded pendant chains end into vinyl groups;

FIG. 5 illustrates, by way of an example, an ester bond forming condensation reaction between undecenoyl anhydride, which is a symmetrical anhydride comprising two identical acyl groups derivable from 10-undecenoic acid, each acyl group having a vinyl group at the end, and thermoplastic poly(vinyl alcohol) in a melt state, wherein at least some of the undecenoyl anhydride reacts with the hydroxyl groups of the thermoplastic poly(vinyl alcohol) in an ester bond forming condensation reaction, such that reaction product is formed which contains 10-undecenoic acid residue and thermoplastic poly(vinyl alcohol) derivative, wherein at least some of the ester bonded pendant chains end into vinyl groups;

FIG. 6 illustrates, by way of an example, an ester bond forming condensation reaction between acetylundecenoyl anhydride, which is an asymmetrical anhydride comprising one acyl group derivable from 10-undecenoic acid having a vinyl group at the end; the other acyl group being derivable from acetic acid, and thermoplastic poly(vinyl alcohol) in a melt state, wherein at least some of the acetylundecenoyl anhydride reacts with the hydroxyl groups of the thermoplastic poly(vinyl alcohol) in an ester bond forming condensation reaction, such that reaction product is formed which contains acetic acid residue, 10-undecenoic acid residue and thermoplastic poly(vinyl alcohol) derivative, wherein at least some of the ester bonded pendant chains end into vinyl groups.

It should be noted that the drawings are not to scale.

### REFERENCE SIGNS

FILM1—polymeric film

REL1—release liner

S1—polymeric support layer

PRIM1—extruded primer layer

TIE1—tie layer

AH1—grafting agent, general

AH2—grafting agent, general

AH3—grafting agent, example

AH4—grafting agent, example

AH5—grafting agent, example

PVA1—thermoplastic PVA

CMP1—thermoplastic polymer covalently bounded to functional vinyl groups, example

CMP2—thermoplastic polymer covalently bounded to functional vinyl groups, example

CMP3—thermoplastic polymer covalently bounded to functional vinyl groups, example

RD1—carboxylic acid residue, example

RD2—carboxylic acid residue, example

RD3—carboxylic acid residue, example

R¹—organic group

R²—organic group

### DETAILED DESCRIPTION

The present application provides a polymeric film for a release liner and a method for preparing a polymeric film for a release liner.

Definition of Polymeric film

A polymeric film, as described herein, refers to one of the three main categories of carrier substrates for industrially manufactured release liners: paper and paperboard, polymeric films, and cellulosic materials coated with polymeric films. A polymeric film comprises mainly polymeric material. A paper-based sheet comprising mainly cellulosic material is excluded from the meaning of a polymeric film.

### Definition of Polymeric Support Layer

The term “polymeric support layer”, as described herein, refers to a layer structure preferably capable of independent existence in the absence of another supporting base. The polymeric support layer comprises any suitable film-forming, polymeric material(s).

Plastics are suitable for this purpose. Illustrative examples include, but not limited to, polyolefins, such as high-density polyethylene (HDPE) and polypropylene (PP); polyester such as polyethylene terephthalate (PET) and its copolymers.

The polymeric support layer may be made into a film by a plastics extrusion process and can be made of one single type of plastic material, a blend of different plastic materials or multi-layered coextrusions.

The polymeric support layer in the form of a film may have been oriented. Illustrative examples include, but not limited to, oriented polypropylene (OPP), oriented polyethylene terephthalate (OPET), BOPET and BOPP, wherein BO means that the substrate has been biaxially oriented by sequential stretching in two mutually perpendicular directions. The film may also be oriented after the primer layer has been extruded, to increase film strength and to facilitate a thinner primer layer.

A polymeric support layer may comprise one or more of the suitable materials. For example, a polymeric support layer may be a BOPET film that has been coated on both sides with a polyolefin material. This way the tough and dimensionally stable PET film is combined with cheap polyolefin resin which makes the film a better carrier web for specialty applications.

A polymeric support layer may comprise other additives, for example compatibilizers. Compatibilizers are made of two parts, one compatible with one of the two polymers to be compatibilized and the other part compatible with the second polymer.

### Definition of Extruded Primer Layer

The term “extruded primer layer”, as described herein, refers to a layer structure that has been made of thermoplastic substance by extrusion. Extrusion is a manufacturing process known by a person skilled in the art. In the extrusion process of manufacturing a layer structure of extruded primer layer, raw material is melted by the mechanical energy generated by turning screws and by heaters arranged along the barrel of the extruder, and the molten material is then forced into a die, which shapes the molten material into a shape in a continuous profile that solidifies during cooling, thereby forming into of an extruded primer layer. There are a variety of dies used in the extrusion in order to form a layer structure, such dies including, but not limited to those used in blown film extrusion, sheet/film extrusion, coextrusion and extrusion coating, all of which are known by a person skilled in the art. Naturally, the extruded primer layer may be realized by means of blown film extrusion, extrusion coating, co-extrusion, lamination, and the like. The extruded primer layer has different properties from the solvent-based primer layer, as well be further explained in the present description.

### Description of Polymeric Films According to the Application

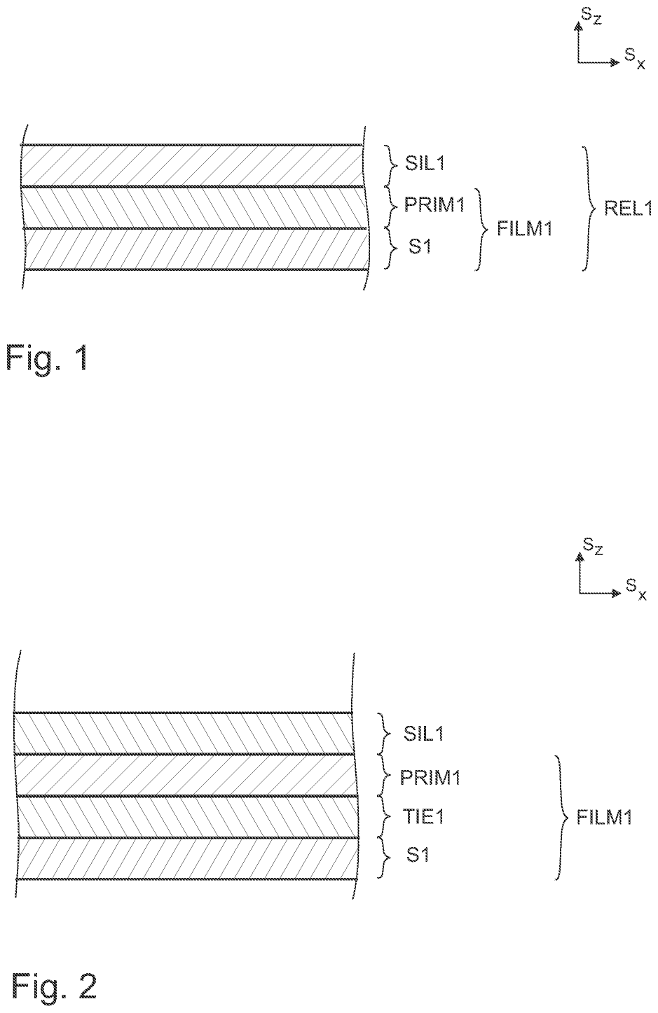

Reference may be made to FIG. 1 and FIG. 2. It is noted that the examples shown in FIG. 1 and FIG. 2 do not bound to any specific embodiments, but merely serve the purpose for explaining the relative location of features denoted with reference signs. Also, FIG. 1 and FIG. 2 show the schematic drawings of examples, not scaled drawings.

The present application provides a polymeric film FILM1 for a release liner REL1, comprising
a polymeric support layer S1 of a first composition comprising one or more polyolefins and/or polyesters, and
an extruded primer layer PRIM1 of a second composition comprising a thermoplastic polymer covalently bonded to functional vinyl groups.

The term “thermoplastic polymer covalently bounded to functional vinyl groups”, as described herein, refers to a thermoplastic polymer wherein the backbone of the polymer has at least one type of functional pendant groups comprising a vinyl group having the formula —CH═CH2. Such functional groups include, for example, vinyl, allyl, acrylic, 4-pentenylic and 10-undecenylic groups. To be extrudable, a material has to be thermoplastic, i.e. a polymer material that becomes pliable or moldable at a certain elevated temperature and solidifies upon cooling.

Further to any of the polymeric films as presented herein according to the present application, the thermoplastic polymer covalently bonded to functional vinyl groups may have preferably been obtained from the reaction product of a molten thermoplastic and a grafting agent containing functional vinyl groups, for example by means of reactive extrusion. The reaction is fast and cost efficient. More preferably, the reaction is a solvent-free reaction. As the reaction does not require any organic solvent or water, obtaining the resulting reaction product does not require any solvent separation or drying, either. The reaction product, which is also in a melt form, may be extruded, either simply for direct coating, or to be cooled down and granulated for easy transportation and storage for later use. Thus, when the thermoplastic polymer has been obtained from the reaction product of a molten thermoplastic and a grafting agent containing functional vinyl groups, the application thereof is more versatile.

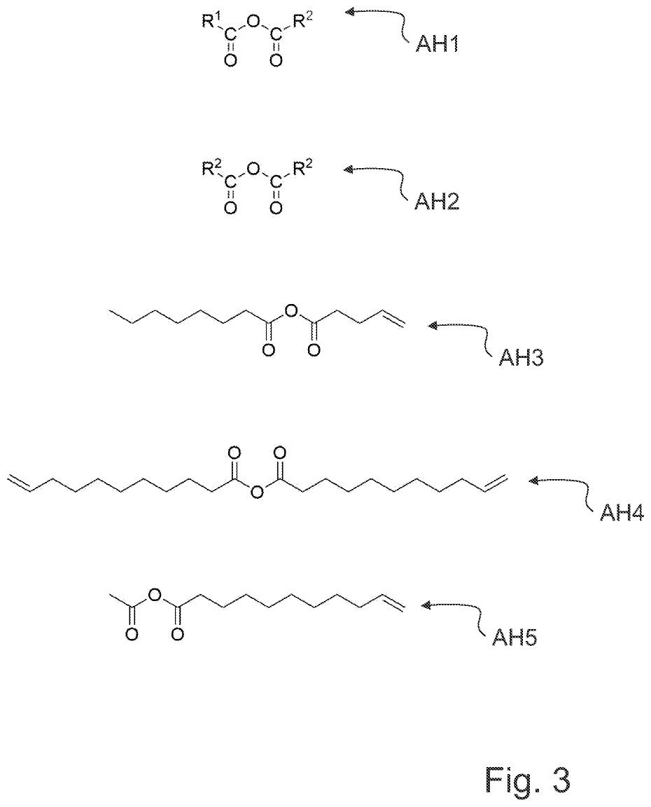

Examples of grafting agents may be organic acid anhydrides, which may be represented by chemical formulas denoted as AH1, AH2, AH3, AH4 and AH5 in FIG. 3, wherein R¹ and R² represent different organic groups.

An organic acid anhydride refers to an organic compound that has two acyl groups bonded to the same oxygen atom. The organic acid anhydride may be aliphatic and a symmetrical anhydride or an asymmetrical anhydride. A symmetrical anhydride, as used herein, refers to an anhydride which has two identical acyl groups, each acyl group ending into a vinyl group. An asymmetrical anhydride, as used herein, refers to an anhydride which has non-identical acyl groups, of which at least one acyl group ends into a vinyl group

Further to any of the polymeric films as presented herein according to the present application, the thermoplastic polymer containing vinyl groups has been formed from a thermoplastic poly(vinyl alcohol) (PVA) having a degree of hydrolysis in the range of 65 to 95 mol-%, such as 65, 70, 75, 80, 85, 90, or 95 mol-%. Degree of hydrolysis below 95% is needed to keep melting point of PVA below 200° C., to avoid thermal degradation. PVA is a stable and non-toxic synthetic polymer, which has excellent film forming, emulsifying and adhesive properties. It is manufactured by hydrolysis of poly(vinyl acetate), which is a soft and sticky polymer at ambient temperature. The degree of hydrolysis should be at least 65% to ensure that the extruded PVA, containing vinyl groups, forms a solid non-sticky film that can be wound into a reel. Thus, the expression “thermoplastic poly(vinyl alcohol)” in this context refers to poly(vinyl alcohol) possessing thermoplasticity. A degree of hydrolysis in the range of 65 to 95 mol-% also contributes to the improved thermoplasticity of poly(vinyl alcohol). The decomposition of thermoplastic PVA during the extrusion should be avoided, as when the polymer would break down to produce water and free vinyl groups, the former in turn leads to bursting at the die and causing holes in the extruded primer layer and/or an uneven surface of the extruded primer layer, while the latter would start cross-linking reaction which in turn cause decreased functional vinyl groups in the extruded primer layer. The risk of poly(vinyl alcohol) decomposition in the elevated temperature in an extruder may be reduced by selecting a thermoplastic poly(vinyl alcohol) grade, wherein the degree of hydrolysis is sufficiently high, such as equal to or higher than 65 mol-%. However, grades that have a degree of hydrolysis equal to or higher than 95 mol-%, may be less preferable as the colouring of poly(vinyl alcohol) may also occur as a result of excessive heating, in particular when the amount of hydroxyl groups in the poly(vinyl alcohol) is very high.

Further to any of the polymeric films as presented herein according to the present application, the thermoplastic, preferably thermoplastic PVA, derivative comprises ester bonded pendant chains of which at least some end into vinyl groups, wherein the pendant chains which end into vinyl groups contain a catenated carbon structure of at least 4 carbon atoms, preferably at least 9, most preferably from 10 to 18 carbon atoms. A catenated carbon structure having a chain length of less than 4 carbon atoms is less preferable, as the short chain length may result in the vinyl group being less accessible for reactions with silicone. A longer chain length than 18 carbon atoms is not desirable either, as it may cause the chain to fold on itself, thus also making the vinyl group less accessible.

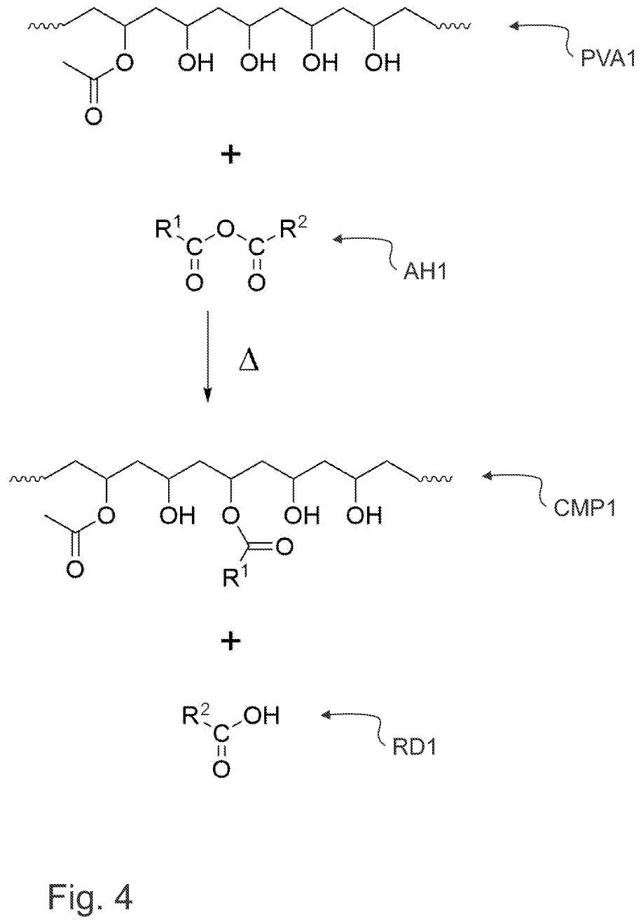

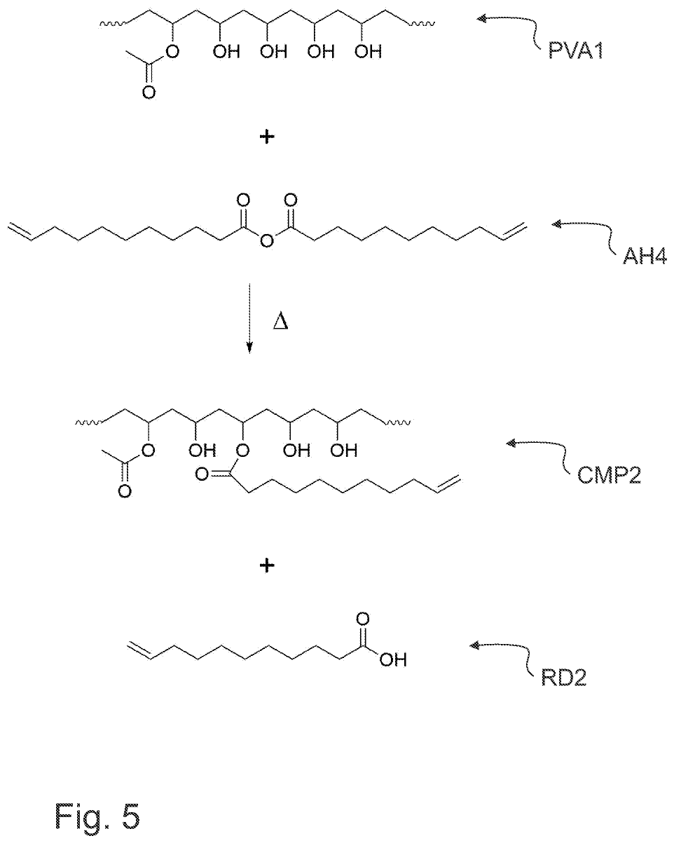

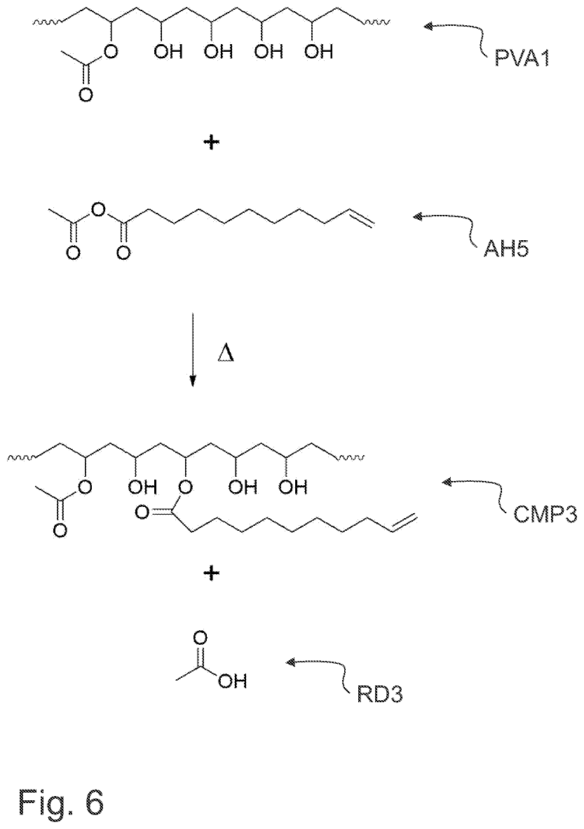

Examples of thermoplastic PVA covalently bounded to functional vinyl groups may be represented by chemical formulas denoted as CMP1 in FIG. 4, CMP2 in FIG. 5 and CMP3 in FIG. 6.

Preferably, an organic acid anhydride that participates into an ester bond forming condensation reaction should have an acyl group which has a catenated carbon structure having a carbon chain length of at least 4 carbon atoms that ends into a vinyl group. This acyl group may thereby form an ester bond with a hydroxyl group of a thermoplastic poly(vinyl alcohol) in a condensation reaction. A catenated carbon structure having a chain length of less than 4 carbon atoms in the organic acid anhydride hydrocarbon chain is not suitable, as the short chain length may lead to interference with the thermoplastic polyvinyl alcohol during the ester bond forming condensation reaction. Preferably, the catenated carbon structure contains 5 or more, preferably at least 9, most preferably from 10 to 18 carbon atoms. A longer chain length is not desirable, as it may lead to chain folding problems during or after the ester bond forming condensation reaction.

As shown in FIG. 3, in an asymmetrical anhydride AH1; AH3; AHS, the two acyl groups of the anhydride are different. In a symmetrical anhydride AH2; AH4, the two acyl groups of the anhydride are identical. The symbols R¹ and R², each alone, represents a functional group, of which at least one or both may have a catenated carbon structure having a carbon chain length of at least 3 carbon atoms that ends into a vinyl group.

Further to any of the polymeric films as presented herein according to the present application, the thermoplastic, preferably thermoplastic PVA, derivative comprises ester bonded pendant chains of which at least some end into vinyl groups, wherein the pendant chains which end into vinyl groups contain a catenated carbon structure of at least 4 carbon atoms, and the extruded primer layer PRIM1 further comprises carboxylic acid residue, wherein the carboxylic acid residue is organic compound that contains the same kind of catenated carbon structures of at least 4 carbon atoms that end into vinyl group as the pendant chains of the thermoplastic poly(vinyl alcohol) derivative. The carboxylic acid residue has been observed to act as a surfactant on a polymeric film FILM1. This effect has been observed even when some of the carboxylic acid residue on the extruded primer layer PRIM1 has been neutralized into the corresponding carboxylate, i.e. the salt of said carboxylic acid residue. The carboxylic acid residue, when arranged on an extruded primer layer PRIM1 of a polymeric film FILM1, may be configured to improve the spreading of a subsequent silicone-based composition applicable as a release coating SIL1 on the polymeric film FILM1.

Examples of carboxylic acid residue may be represented by chemical formulas denoted as RD1 in FIG. 4, RD2 in FIG. 5 and RD3 in FIG. 6.

The second composition may comprise also salt of the carboxylic acid residue, i.e. carboxylate.

Further to any of the polymeric films as presented herein according to the present application, the second composition, comprising a thermoplastic derivative covalently bounded to functional vinyl groups, may further comprise
one or more additives, such as plasticizers, and/or
one or more non-thermoplastic material, such as starch or carboxymethyl cellulose (CMC).

The use of plasticizers leads to better processability. Examples of such plasticizer are glycol, polyglycol, glycerine or the like.

Using a compatibilizer would be beneficial if the polymeric support layer S1 and the extruded primer layer PRIM1 have polymers with different polarities.

In an example, the extruded primer layer PRIM1 comprises thermoplastic PVA covalently bounded to functional vinyl groups, and the polymeric support layer S1 comprises polyethylene and/or polypropylene. Using a compatibilizer improves interfacial adhesion by making the support layer surface more polar and capable to form hydrogen bonds or covalent bonds with hydroxyl groups of thermoplastic PVA. Extruded primer layer PRIM1 can form an improved interfacial adhesion with a sufficiently polar surface. An additional tie layer TIE1 is a better alternative than a mixture of nonpolar polymer and compatibilizer, because it results in higher density of polar groups available on the surface.

Further to any of the polymeric films as presented herein according to the present application, wherein the thermoplastic polymer covalently bounded to vinyl groups has been formed from a thermoplastic poly(vinyl alcohol), may further comprises at least one compatibilizer, so that

at least one of the polymeric support layer S1 and the extruded primer layer PRIMA1 further comprises at least one compatibilizer, being polyolefin grafted with maleic anhydride, acrylic acid, or glycidyl methacrylate; and additionally or alternatively,
the polymeric film FILM1 further may further comprise a tie layer TIE1 between the polymeric support layer and the extruded primer layer, said tie layer TIE1 comprising at least one compatibilizer, such as polyolefin grafted with maleic anhydride, acrylic acid, or glycidyl methacrylate.

In some examples, the extruded primer layer PRIM1 may comprise a compatibilizer, such as anhydride modified polyolefin. The anhydride, typically maleic anhydride, reacts with alcohols to form ester crosslinks.

In some examples, the support layer S1 may comprise a compatibilizer, such as anhydride modified polyolefin. The anhydride present on the surface of the polymeric support layer S1 reacts with alcohols present in the extruded primer layer PRIM1 to form ester crosslinks, and thus, the adhesion between the extruded primer layer PRIM1 and the polymeric support layer S1 is further improved.

The extruded primer layer PRIM1 has excellent adherence to the overlying silicone coating SIL1. On the polymeric film FILM1 according to the present application, a silicone resin coating SIL1 may be applied, i.e. a release coating, which is subsequently thermally cured in a catalytic hydrosilation reaction, on a surface of the extruded primer layer PRIM1 of the polymeric film FILM1, thereby a release linear REL1 comprising a silicone resin coating SIL1, a polymeric support layer S1, and an extruded primer layer PRIM1 situated between the silicone resin coating SIL1 and the polymeric support layer S1, is formed. The catalytic hydrosilation reaction, also denoted as hydrosilylation, refers to a covalent bond formation between functional vinyl groups in the silicone base polymer and silane hydride (Si—H) groups in the cross-linker compound in the presence of a platinum catalyst. This reaction results into a solid release layer SIL1, on the surface of the extruded primer layer PRIM1. Due to the functional vinyl groups present on the surface of the extruded primer layer PRIM1, during the catalytic hydrosilation reaction, a covalent bond also forms between functional vinyl groups in the extruded primer layer PRIM1 and silane hydride (Si—H) groups in the cross-linker. The covalent bonds between the silicone coating SIL1 and the extruded primer layer PRIM1 contribute a strong interaction and therefore promote the anchorage of the silicone coating SIL1 to the polymeric film FILM1.

Furthermore, the extruded primer layer PRIM1 contributes an improved coverage of surface for the subsequent silicone coating, which in turns improves the consistency of the release value. Release value is used to denote the minimum amount of force required to detach a label or excess matrix material from the release liner. A high-quality silicone coating SIL1 requires good coverage of the polymeric film FILM1. Uncoated areas, pinholes, and contaminations will increase the release value and give poor release stability over time. The surface of the polymeric film FILM1 with less defects, such as pinholes, also promotes the good coverage of the silicone coating. Pinhole is a pore-like penetration which is usually present in solvent-based coatings due to the entrapment of moisture, air, solvents or other fluids. The number of pinholes on the surface of the extruded primer layer PRIM1 according to the present application has been significantly decreased. This is because the primer layer composition for the extruded primer layer PRIM1 does not contain water or solvent, and thus entrapping moisture or volatile solvent is avoided. Further, as there are less holes to be filled with the silicone coating, the polymeric film FILM1 according to the present application can be siliconized with a lower silicone coat weight, as compared with the primer layer wherein the aqueous-dispersion- or solvent-based coating is used. Thus, cost-efficiency of preparing silicone coating can be improved.

Further to any of the polymeric films as presented herein according to the present application, the polymeric primer layer has at least one of the following properties:
the PPS roughness value is less than 1 μm,
the extruded primer layer PRIM 1 comprising thermoplastic polymer covalently bound to functional vinyl groups has a coat weight of at least 0.6 g/m²,
the extruded primer layer PRIM1 contains functional vinyl groups in an amount of at least 0.06 mmol/m²,
the thermoplastic polymer contains a vinyl group molality bᵥᵢₙ which is in the range of 0.05 mmol/g to 2.00 mmol/g, preferably in the range of 0.10 mmol/g to 1.10 mmol/g, and most preferably in the range of 0.15 mmol/g to 0.80 mmol/g, determined as millimoles per gram of dry thermoplastic polymer, when determined by iodometric titration method following the standard ISO 396 1:2009(E).

The polymeric film according to the present application having a Parker Print-Surf (PPS) roughness value of less than 1 μm contributes a smooth surface for the subsequent silicone coating. The measurement of PPS roughness may be obtained by using a Parker Print Surface roughness tester, which is known by a person skilled in the art. Less silicone coating solution is needed for a smoother surface. According to the present application, the extruded primer layer contributes a smooth surface for subsequent silicone coating. The polymeric film according to the application can be siliconized with a less silicone coat weight, for example of 0.6 to 0.8 g/m2, or even less. Therefore, it is a desirable solution economically. Furthermore, the extruded primer layer has a consistent surface roughness which contributes consistent release values of the silicone coating.

The polymeric film according to the present application is substantially pinhole free. This contributes a good coverage for the subsequent silicone coating. This ensures the good release value of the release layer.

According to the present application, the disclosed amounts of the thermoplastic polymer covalently bounded to functional vinyl groups are proven to contribute a good silicone anchorage. The coat weight may be, for example, 0.5-10.0 g/m², preferably 0.5-4.0 g/m², more preferably 1.0-2.0 g/m². The experimental result has supported that the extruded primer layer PRIM1, containing the thermoplastic polymer, such as thermoplastic PVA covalently bounded to functional vinyl groups, in an amount 0.6 g/m², contributes excellent adherence between the polymeric film and the silicone layer in a rub-off test.

The same effect has been observed, that the disclosed amounts of vinyl groups are proven to contribute a good silicone anchorage. The functional vinyl groups contained in the extruded primer layer PRIM1, which comprises for example thermoplastic PVA covalently bounded functional vinyl groups, may be at a vinyl group density in a range of, for example, 0.025-20 mmol/m², preferably 0.05-4.0 mmol/m², and more preferably 0.15-1.6 mmol/m².

The same effect has been observed, when the thermoplastic polymer contains a vinyl group molality bᵥᵢₙ which is in the range of 0.05 mmol/g to 2.00 mmol/g, preferably in the range of 0.10 mmol/g to 1.10 mmol/g, and most preferably in the range of 0.15 mmol/g to 0.80 mmol/g, determined as millimoles per gram of dry thermoplastic polymer, such as thermoplastic PVA covalently bounded to functional vinyl groups, when determined by iodometric titration method following the standard ISO 3961:2009(E). Therefore, it is a desirable solution economically. Thus, it is possible to obtain a product having good rub-off properties. Further, the amount of a release coating containing silicone compound may be reduced. Still further, less amount of release coating also requires less platinum catalyst for curing to take place. Because siliconizing a reactive surface layer may require less platinum catalyst for silicone curing to take place, the manufacturing costs of the release liner may be reduced.

Further to any of the polymeric films as presented herein according to the present application, the polymeric support layer S1 may comprise one or more of high-density polyethylene (HDPE), polypropylene (PP), polybutylene, polyethylene terephthalate (PET) and PET copolymer, as these polymers are especially suitable for release liners and inexpensive. The extruded primer layer according the present application is applicable to a wide diversity of polymeric support layers.

In one example, the thermoplastic polymer covalently bonded to functional vinyl groups has been formed from a thermoplastic poly(vinyl alcohol), and the polymeric support layer S1 comprises a PET copolymer. The PET copolymer can be melt processed below 210° C., a temperature usable also for melt processing the thermoplastic poly(vinyl alcohol) covalently bounded to functional vinyl groups. Common comonomers include cyclohexanedimethanol (denoted as PET-G) and isophthalic acid, and they both interfere with crystallization of PET, thus lowering its melting point.

In one example, the polymeric film may further comprise a tie layer TIE1 between the extruded primer layer PRIM1 and the polymeric support layer S1. The thermoplastic polymer covalently bonded to functional vinyl groups has been formed from a thermoplastic poly(vinyl alcohol), and the polymeric support layer S1 comprises a polypropylene, and the tie layer TIE1 comprises polypropylene grafted with maleic anhydride.

### Detailed Description of Methods According to the Application

The present application further provides a method for preparing a polymeric film FILM1 for a release liner REL1, said comprising extruding a molten second composition comprising at least one thermoplastic polymer covalently bounded to functional vinyl groups.

The method according to the present application may comprise
extruding a molten first composition comprising one or more polyolefins and/or polyesters, thereby obtaining an extruded first composition,
extruding a molten second composition comprising a thermoplastic polymer covalently bonded to functional vinyl groups, thereby obtaining an extruded second composition,
allowing the temperature of the extruded molten first composition to decrease below its melting point, thereby forming a polymeric support layer S1,
allowing the temperature of the extruded molten second composition to decrease below its melting point, thereby forming an extruded primer layer PRIM1, and
forming the polymeric film FILM1 comprising the polymeric support layer S1 and the extruded primer layer PRIM1.

The resulting product, the polymeric film FIM1, of the method according to the present application, has the effects as discussed above.

The second composition, comprising extrudable polymeric material, including the thermoplastic polymer covalently bounded to functional vinyl groups as defined above, as well as the possible additives, such as plasticizers or compatibilizers, may be fed to an extruder to form the molten second composition. This may be applicable for extrusion coating the resulting extruded primer layer PRIM1 onto the surface of the polymeric support layer S1, which may be a carrier sheet traveling past the extruder die slot. The die extrudes the polymeric material vertically through a narrow slot to form a thin low viscosity coating of a melt of uniform thickness that uniformly coats the carrier sheet which is continuously moving at high speed past the extruder die slot. As mentioned above, due to the functional vinyl groups present on the surface of the extruded primer layer PRIM1, during the catalytic hydrosilation reaction of curing the silicone coating, a covalent bond forms between functional vinyl groups in the extruded primer layer PRIM1 and silane hydride (Si—H) groups in the cross-linker in the silicone coating composition. The surface of the extruded primer layer is reactive to the silicone coating only during the course of applying the silicone coating. This provides a great flexibility in the arrangement of production line in the industry. The thickness of the extruded primer layer PRIM 1 may be controlled by winding speed. Therefore, the guaranteed properties and quality of the polymeric films produced in the industrial scale may be better managed. Further, extrusion coating operations use high melt temperatures to lower the melt viscosity. This improves coating thickness uniformity and adhesion.

Preferably, the method may further comprise
extruding a third composition comprising a compatibilizer, thereby obtaining an extruded third composition, and
allowing the temperature of the extruded molten third composition to decrease below its melting point, thereby forming a tie layer TIE1,
   such that the tie layer TIE1 is situated between the polymeric support layer S1 and the extruded primer layer PRIM1.

According to the methods of the present application, at least two of the above-mentioned molten compositions may be co-extruded. For example, the first composition and the second composition may be co-extruded. For example, the first composition, the second composition and the third composition may be co-extruded.

The resulting product, the polymeric film FIM1, of the method according to the present application, has the effects as discussed above.

The extrusion apparatus for implementing the co-extrusion method according to the present application may comprise, for example at least two extruders, a film nozzle, a cooling cylinder, an optional orientation/stretching unit, and a rewinder. The molten first composition and the molten second composition, and optionally the third composition, feed from extruders, respectively, converge in the nozzle and become laminated together into a single film. As mentioned above, due to the functional vinyl groups present on the surface of the extruded primer layer PRIM1, during the catalytic hydrosilation reaction of curing the silicone coating, a covalent bond forms between functional vinyl groups in the extruded primer layer PRIM1 and silane hydride (Si—H) groups in the cross-linker in the silicone coating composition. The surface of the extruded primer layer is reactive to the silicone coating only during the course of applying the silicone coating. This provides a great flexibility in the arrangement of production line in the industry. Layer ratios may be controlled by the screw rotation rates, and the total film thickness may be controlled by winding speed. Film orientation may be performed according the actual need. Therefore, the predictability and guaranteed properties and quality of the polymeric films produced in the industrial scale may be better managed.

For implementing one of the methods as presented herein according to the present application, an extruder may be used to convert a solid composition comprising a thermoplastic polymer containing vinyl groups, into a melt at the appropriate temperature required for coating, thereby obtaining a molten second composition comprising a thermoplastic polymer containing vinyl groups. Preferably, said thermoplastic polymer has been obtained from the reaction product of a molten thermoplastic and a grafting agent containing functional vinyl groups.

The same or another extruder may be used to allow a chemical reaction for modifying a thermoplastic to result a thermoplastic polymer containing vinyl groups in the molten state at the appropriate temperature required for coating, thereby obtaining a molten second composition comprising a thermoplastic polymer containing vinyl groups. The thermoplastic polymer may be obtained from the reaction product of a molten thermoplastic and a grafting agent, for example by means of reactive extrusion.

Further to any of the methods as presented herein according to the present application, the thermoplastic polymer covalently bounded to functional vinyl groups may have been obtained from the reaction product of a molten thermoplastic and a grafting agent covalently bounded to functional vinyl groups. Such a method is fast and cost efficient. The reaction is more advantageously a solvent-free reaction. As the reaction does not require any organic solvent or water, obtaining the resulting reaction product does not require any solvent separation or drying, either. The reaction product, which is also in a melt form, may be extruded, either simply for direct coating, or to be cooled down and granulated for easy transportation and storage for later use. The reaction is easy to implement in a reactor such as an extruder, and hence does not suffer from mixing problems, which may be present in solvent-based reactions.

Further to any of the methods as presented herein according to the present application, the thermoplastic polymer containing vinyl groups has been formed from a thermoplastic poly(vinyl alcohol) (PVA) having a degree of hydrolysis in the range of 65 to 95 mol-%, such as 65, 70, 75, 80, 85, 90, or 95 mol-%. The definition of such a thermoplastic poly(vinyl alcohol) and the advantages brought have been described above. The resulting product, the polymeric film FIM1, has the effects as discussed above.

Further to any of the methods as presented herein according to the present application, the thermoplastic polymer, preferably thermoplastic PVA, comprises ester bonded pendant chains of which at least some end into vinyl groups, wherein the pendant chains which end into vinyl groups contain a catenated carbon structure of at least 4 carbon atoms, and the extruded primer layer PRIM1 further comprises carboxylic acid residue, wherein the carboxylic acid residue is organic compound that contains the same kind of catenated carbon structures of at least 4 carbon atoms that end into vinyl group as the pendant chains of the thermoplastic poly(vinyl alcohol) derivative. The carboxylic acid residue has been observed to act as a surfactant on a polymeric film FILM1. This effect has been observed even when some of the carboxylic acid residue on the extruded primer layer PRIM1 has been neutralized into the corresponding carboxylate, i.e. the salt of said carboxylic acid residue. The carboxylic acid residue, when arranged on an extruded primer layer PRIM1 of a polymeric film FILM1, may be configured to improve the spreading of a subsequent silicone-based composition applicable as a release coating SIL1 on the polymeric film FILM1. The resulting product, the polymeric film FIM1, has the effects as discussed above.

Examples of thermoplastic PVA covalently bounded to functional vinyl groups may be represented by chemical formulas denoted as CMP1 in FIG. 4, CMP2 in FIG. 5 and CMP3 in FIG. 6. Examples of carboxylic acid residue may be represented by chemical formulas denoted as RD1 in FIG. 4, RD2 in FIG. 5 and RD3 in FIG. 6.

As illustrated in FIGS. 4, 5 and 6, when an aliphatic organic acid anhydride AH1; AH2; AH3; AH4; AH5 reacts in a condensation reaction in a melt state with a hydroxyl group of thermoplastic poly(vinyl alcohol) PVA1, one of the acyl groups forms an ester bond with the hydroxyl group of the poly(vinyl alcohol) PVA1, while the other acyl group becomes a carboxylic acid residue RD1; RD2; RD3. The formed thermoplastic poly(vinyl alcohol) derivative CMP1; CMP2; CMP3 thereby comprises ester bonded pendant chains of which at least some end into vinyl groups, wherein the pendant chains which end into vinyl groups contain a catenated carbon structure of at least 4 carbon atoms. Statistically, it is equally likely for either or the acyl groups of the aliphatic anhydride to participate in the ester bond forming condensation reaction. Thus, also the carboxylic acid residue RD1; RD2; RD3 is an organic compound that contains the same kind of catenated carbon structure of at least 4 carbon atoms that end into vinyl group, as the ester bonded pendant chains of the thermoplastic poly(vinyl alcohol) derivative CMP1; CMP2; CMP3.

Further to any of the methods as presented herein according to the present application, the second composition, comprising a thermoplastic polymer covalently bounded to functional vinyl groups, may further comprise
one or more additives, such as plasticizers, and/or
one or more non-thermoplastic material, such as starch or carboxymethyl cellulose (CMC).

The use of plasticizers leads to better processability. Examples of such plasticizer are glycol, polyglycol, glycerine or the like. The resulting product, the polymeric film FIM1, has the advantageous effects as discussed above.

Further to any of the method as presented herein according to the present application, wherein the thermoplastic polymer covalently bounded to vinyl groups has been formed from a thermoplastic poly(vinyl alcohol), the polymeric film FILM1 may further comprise a tie layer TIE1 between the polymeric support layer S1 and the extruded primer layer PRIM1, said tie layer TIE1 comprising at least one compatibilizer, such as polyolefin grafted with maleic anhydride, acrylic acid, or glycidyl methacrylate.

In some examples, the extruded primer layer PRIM1 may comprise a compatibilizer, such as anhydride modified polyolefin. The anhydride, typically maleic anhydride, reacts with alcohols to form ester crosslinks.

In some examples, the support layer S1 may comprise a compatibilizer, such as anhydride modified polyolefin. The anhydride present on the surface of the polymeric support layer S1 reacts with alcohols present in the extruded primer layer PRIM1 to form ester crosslinks, and thus, the adhesion between the extruded primer layer PRIM1 and the polymeric support layer S1 is further improved.

Further to any of the methods as presented herein according to the present application, the extruded primer layer PRIM1 has at least one of the following properties:
the PPS roughness value is less than 1 μm,
the extruded primer layer PRIM 1 comprising thermoplastic polymer covalently bound to functional vinyl groups has a coat weight in a range of 0.5-10.0 g/m², preferably 0.5-4.0 g/m², for example at least 0.6 g/m², more preferably 1.0-2.0 g/m²,
the extruded primer layer PRIM1 contains functional vinyl groups in an amount of 0.025-20 mmol/m², preferably 0.05-4.0 mmol/m², for example at least 0.06 mmol/m², more preferably 0.15-1.6 mmol/m²,
the thermoplastic polymer contains a vinyl group molality bᵥᵢₙ which is in the range of 0.05 mmol/g to 2.00 mmol/g, preferably in the range of 0.10 mmol/g to 1.10 mmol/g, and most preferably in the range of 0.15 mmol/g to 0.80 mmol/g, determined as millimoles per gram of dry thermoplastic polymer, when determined by iodometric titration method following the standard ISO 396 1:2009(E).

The effects brought by these properties have been described above. The resulting product, the polymeric film FIM1, has the advantageous effects as discussed above.

Further to any of the methods as presented herein according to the present application, the polymeric support layer S1 may comprise one or more of high density polyethylene (HDPE), polypropylene (PP), polybutylene, polyethylene terephthalate (PET) and PET copolymer, as these polymers are especially suitable for release liners and inexpensive. The extruded primer layer according the present application is applicable to a wide diversity of polymeric support layers.

In one example, the thermoplastic polymer covalently bounded to functional vinyl groups has been formed from a thermoplastic poly(vinyl alcohol), and the polymeric support layer S1 comprises a PET copolymer. The PET copolymer can be melt processed below 210° C., a temperature usable also for melt processing the thermoplastic poly(vinyl alcohol) covalently bounded to functional vinyl groups. Common comonomers include cyclohexanedimethanol (denoted as PET-G) and isophthalic acid, and they both interfere with crystallization of PET, thus lowering its melting point.

In one example, the polymeric film may further comprise a tie layer TIE1 between the extruded primer layer PRIM1 and the polymeric support layer S1. The thermoplastic polymer covalently bounded to functional vinyl groups has been formed from a thermoplastic poly(vinyl alcohol), and the polymeric support layer S1 comprises a polypropylene, and, the tie layer TIE1 comprises polypropylene grafted with maleic anhydride.

Further to any of the method as presented herein according to the present application, the method may further comprise, prior to providing a molten second composition
reacting a molten thermoplastic and a grafting agent containing functional vinyl groups, preferably in a solvent-free reaction, thereby obtaining a thermoplastic polymer covalently bounded to functional vinyl groups.

The resulting product, the polymeric film FIM1, has the advantageous effects as discussed above.

Further to any of the methods as presented herein according to the present application, wherein the thermoplastic derivative covalently bounded to vinyl groups has been formed from a thermoplastic poly(vinyl alcohol), may further comprises at least one compatibilizer, so that

at least one of the polymeric support layer S1 and the extruded primer layer PRIMA1 further comprises at least one compatibilizer, being polyolefin grafted with maleic anhydride, acrylic acid, or glycidyl methacrylate. In some examples, the polymeric film FILM1 further comprises a tie layer TIE1, between the polymeric support layer S1 and the extruded primer layer PRIM1, comprising at least one compatibilizer, such as polyolefin grafted with maleic anhydride, acrylic acid, or glycidyl methacrylate.

In some examples, the extruded primer layer PRIM1 comprises a compatibilizer, such as anhydride modified polyethylene (AMP). The anhydride reacts with alcohols to form ester crosslinks.

In some examples, the support layer S1 comprises a compatibilizer, such as anhydride modified polyethylene (AMP). The anhydride present on the surface of the polymeric support layer S1 reacts with alcohols present in the extruded primer layer PRIM1 to form ester crosslinks, and thus, the adhesion between the extruded primer layer PRIM1 and the polymeric support layer S1 is further improved.

Further to any of the methods as presented herein according to the present application, a step of providing the molten second composition is perform:
heating thermoplastic poly(vinyl alcohol) having hydroxyl groups, wherein the thermoplastic poly(vinyl alcohol) has been dried and has a degree of hydrolysis in the range of 65 to 95 mol-%,
   and
admixing grafting agent with the thermoplastic poly(vinyl alcohol), wherein said grafting agent t is an organic acid anhydride having at least a chain which has a catenated carbon structure of at least 4 carbon atoms and which ends into a vinyl group,
   such that a mixture is obtained which contains molten thermoplastic poly(vinyl alcohol) having hydroxyl groups and organic acid anhydride which contains chains which end into vinyl groups, and
mixing the mixture at a temperature which is above the melting point of the mixture, thereby causing a reaction in a melt state, wherein at least some of the organic acid anhydride reacts with the hydroxyl groups of the thermoplastic poly(vinyl alcohol) in an ester bond forming condensation reaction,
   such that reaction product, being the second composition, is formed which contains
carboxylic acid residue of the ester bond forming condensation reaction, wherein at least some of said carboxylic acid residue contains chains which end into vinyl groups, and
thermoplastic poly(vinyl alcohol) derivative which contains ester bonded pendant chains of which at least some end into vinyl groups.

Examples of providing the molten second composition may be illustrated by the Chemical equations in FIG. 4 to FIG. 6.

Typically, a temperature in a range of 170 to 210° C. may be used for the condensation reaction. The suitable temperature range is limited from the lower end by the melting point of the thermoplastic poly(vinyl alcohol) PVA1 and the mixture. The suitable temperature range is limited from the upper end by the decomposition temperature of the poly(vinyl alcohol) PVA1 and/or its derivative. Most preferably, said temperature is in a range of 170 to 190° C., which reduces the likelihood of thermal decomposition of the thermoplastic poly(vinyl alcohol) PVA1 and/or its derivative. The reaction in a melt state is preferably carried out without adding a solvent. The lack of added solvents enables a small reaction volume. The duration of the reaction in a melt state may be less than 5 minutes, preferably less than 1 minute, more preferably less than 20 seconds. If desired, an inhibitor may be used to inhibit spontaneous radical polymerization of vinyl groups and/or to inhibit a cross-linking reaction of the thermoplastic poly(vinyl alcohol) PVA1 and/or its derivative. An example of such an inhibitor is butylated hydroxytoluene, which can act as a free radical scavenger that suppresses radical reactions, such as polymerization and cross-linking. Further, if desired, a homogeneous or heterogeneous catalyst may be used to accelerate the ester bond forming condensation reaction. A suitable catalyst may be, for example, a Bronsted acid (e.g. sulfuric acid), a Lewis acid (e.g. tin(II) octoate), or a Bronsted/Lewis base (e.g. alkaline metal alkoxide or carbonate). Further, pyridine may be used as such a catalyst. A preferred catalyst is 1-methylimidazole, which has a high catalytic activity, which is in the range of 4×10² times higher than the catalytic activity of pyridine.

If desired, at least some of the carboxylic acid residue in the reaction product may be neutralized with an alkaline reagent, such as NaOH, thereby forming a salt of the carboxylic acid residue, i.e. a carboxylate.

The thermoplastic poly(vinyl alcohol) derivative contained in the reaction product may have a degree of hydrolysis in the range of 60% to 90%. The thermoplastic poly(vinyl alcohol) derivative contained in the reaction product may further have a melt flow index in a range of 0.5-300 g/10 min. The melt flow index may be determined according to standard ISO 1133-1:2011 (210° C., 2.16 kg) with a melt point measuring device, or alternatively by using a differential 30 scanning calorimetry method.

A melt state reaction, in contrast can be done in large volumes with a compact device, in a short span of time which enables centralized production and easy distribution of solid, water soluble reaction product to paper manufacturing sites all over the world.

Further to any of the methods as presented herein according to the present application, the method may further comprise orienting the polymeric film (FILM1). It allows firstly extruding the molten compositions in the form of a thicker layer, thereby further eliminate the surface deficiencies such as pinholes, and then the orientation may further thin the polymeric film to a desired thickness and smoothness.

The polymeric films (FILM1) and the methods for manufacturing the polymeric films (FILM1) are especially suitable for release liners. It is thus provided also release liners comprising
the polymeric film according to the present application, or the polymeric films obtainable by the methods according to the present application, and
a silicone coating layer on top of the polymeric film.

### EXAMPLES

### Example 1

### Melt State Reaction of poly(vinyl alcohol) with 10-undecenoyl anhydride

An experimental study was carried out, wherein a mixture containing thermoplastic polyvinyl alcohol and 10-undecenoyl anhydride was arranged to react in an ester bond forming condensation reaction in melt state such that reaction product containing thermoplastic polyvinyl alcohol derivative and carboxylic acid residue was obtained. 10-undecenoyl anhydride is a symmetrical anhydride condensed from two 10-undecenoic acid molecules having a vinyl group at the end. 10-undecenoyl anhydride therefore has two chains which have a catenated carbon structure and which end into a vinyl group. The amount of 10-undecenoyl anhydride that was admixed with the thermoplastic polyvinyl alcohol was 5 wt.-%, determined of the total weight of the mixture. The reaction was carried out using a twin-screw extruder (Brabender®, counter-rotating, 32 mm screw diameter, 330.7 mm screw length) which contained a feeding unit, three heating zones and a die zone for extruding the material.

In the experimental study, an amount of 1.9 kg of thermoplastic polyvinyl alcohol (Kuraray POVAL® 3-80 grade) having a degree of hydrolysis of 80 mol-% was first dried in an oven at a temperature of 60° C. for 24 hours, thereby obtaining dry thermoplastic polyvinyl alcohol. The dry thermoplastic polyvinyl alcohol was then fed via the feeding unit to the extruder, together with 0.1 kg of 10-undecenoyl anhydride. The extruder screws were rotated at 30 rpm. The three heating zones were adjusted to have a temperature profile that provided smooth runnability. The first heating zone adjacent to the feeding unit had a temperature of 190° C., the second heating zone had a temperature of 190° C., as well, and the third heating zone had a temperature 195° C. The extrusion die zone was set to have a temperature of 200° C. Thus, the 10-undecenoyl anhydride was reacted in an ester bond forming condensation reaction with the thermoplastic polyvinyl alcohol in a melt state, yielding thermoplastic polyvinyl alcohol derivative which contained ester bonded 10-undecenoyl groups. The reaction product was extruded through the die and air cooled below the melting point of the mixture and granulated to form a solid reaction product, i.e. an extrudate. In the following examples, said extrudate is denoted as mPVA.

### Example E1

### A Polymeric Film Made by Extrusion Coating of mPVA on PET

The mPVA, obtained from Example 1, in pellet form was dried in vacuum at 65° C. for 16 h prior to extrusion. Pellets were fed from a hopper to an extruder having a narrow film die able to apply polymer melt on the surface of a passing film moving from unwinder to rewinder. Commercially available PET film with 50 μm thickness was wound from roll to roll, passing the extruder die opening and continuing via chill roll nip to rewinder. The die extruded the mPVA vertically through a narrow slot to form a thin low viscosity coating of a melt of uniform thickness that uniformly coats the PET sheet which was continuously moving at a speed of 2.5 m/min past the extruder die slot. The coated PET sheet passed through a nip between the pressure roll and a chill roll. The nip pressure applied by the pressure roll provides smoothing of the exposed face of the coating. The extruded coating was immediately cooled by contact with the chill roll which hardened the extruded coating.

The coat weight of mPVA used was 4 g/m², corresponding to vinyl groups in an amount of 0.68 g/m².

### Example E2

### A Polymeric Film Made by Coextrusion of PET Copolymer (PET-G) and mPVA

The mPVA, obtained from Example 1, and commercially available PET copolymer (PET-G, Akestra 90), in pellet form were provided as starting material.

The polymers were dried in a vacuum oven at 65° C. for 16 hours prior to extrusion. A film extruder suitable for extruding 1-3 layers comprised three extruders, a three-channel feed block, a film die, a cooling cylinder, orientation unit and a rewinder. The extruders had single screws with diameters of 30, 45, and 30 mm and respective L/d ratios of 30, 25, and 30. Feed rates of all components were controlled by a gravimetric feed regulator. The PET-G was fed into a large extruder and mPVA was fed into a small extruder. The extruders had ten heating zones that were adjusted to a steadily increasing temperature profile. A range of 190-220° C. was used for PET-G and 150-200° C. for mPVA. The film nozzle was adjusted to 220° C. Polymer melt feeds from all extruders converged in the feed block and passed through the nozzle fused together as a single film. Feed rates of PET-G and mPVA were 30 and 2.3 kg/h, respectively. After exiting the nozzle, the melt was quickly cooled by the chill roll that was set to 55° C., thereby forming a polymeric film. The polymeric film thus had a polymeric support layer of PET copolymer and an extruded primer layer of mPVA. The formed film precursor was passed through the orientation unit, stretching it in machine direction to the final thickness of 50 μm. The extruded primer layer containing the mPVA had a coat weight of 4.3 g/m² estimated from the feed ratio and total thickness and had vinyl group density of 0.73 mmol/m².

### Example E3

### A Polymeric Film Made by Coextrusion of Polypropylene and mPVA

The procedure of coextrusion was repeated as in the Example E2, except that polypropylene (Moplen EP 310D HP) was used instead of PET copolymer. Temperature ranges were 225-235° C. for PP and 150-200° C. for mPVA. Film nozzle was adjusted to 230° C. Feed ratios were 10 kg/h for PP and 2 kg/h for mPVA. Final film thickness was 45 μm and the extruded primer layer containing the mPVA had a coat weight of 8.9 g/m² and had vinyl group density of 1.5 mmol/m².

### Example E4

### A Polymeric Film Made by Coextrusion of PP, mPVA and a Compatibilizer

The procedure of coextrusion was repeated as in the Example E3, except that a third composition of PP-MAH (polypropylene grafted with maleic anhydride) based compatibilizer (Bynel 50E739) was also coextruded as a tie layer, to produce a three-layered film. Temperature ranges were 225-235° C. for PP, 210-235° C. for PP-MAH, and 150-200° C. for mPVA. Film nozzle was adjusted to 230° C. Feed ratios were 10 kg/h for PP, 4 kg/h for PP-MAH, and 2 kg/h for mPVA. Final film thickness was 45 μm and the extruded primer layer containing the mPVA had a coat weight of 6.7 g/m² and had vinyl group density of 1.1 mmol/m².

### Comparative Example C1

### A Polymeric Film Made by Coextrusion of PET Copolymer and Unmodified PVA

The procedure of coextrusion was repeated as in the Example E2, except that commercially available PVA (Poval 3-80) was used instead of mPVA of Example 1. Same film extruder with same settings was used to coextrude PET-G copolymer (Akestra 90) and PVA (Poval 3-80) to obtain a two-layer film. The PVA layer had a coat weight of 4.3 g/m² and had no vinyl groups.

Comp. Example C2

### A Polymeric Film Made by Coextrusion of PP, a Compatibilizer and Unmodified PVA

The coextrusion was repeated as in the Example E4, except that commercially available PVA (Poval 3-80) was used instead of mPVA of Example 1. Same film extruder with same settings was used to coextrude PP, PP-MAH and PVA (Poval 3-80) to obtain a three-layer film. The PVA layer had a coat weight of 6.7 g/m² and had no vinyl groups.

### Example 3

### A Method to Determine Silicone Adhesion

The polymeric films obtained from Examples E2, E3, E4, C1 and C2 were subject to siliconization.

Siliconization refers to coating of a substrate with silicone resin prepared of Wacker Dehesive SFX 251 and V58 cross-linker, using C05 catalyst (all components provided by Wacker). The silicone resin applied on the paper substrate was prepared by stirring 100 parts per weight of the Dehesive SFX 251 with 11.9 parts of the V58 cross-linker for 2 minutes, then adding 2.5 part of the C05 platinum catalyst and stirring for 5 minutes. The silicone resin thus prepared was then applied on top of the substrate by a laboratory blade coater and cured for 1 minute at 105° C., thereby curing the silicone resin into a release layer and forming a release liner. Each sample sheet was coated with an amount of approximately 0.7 g/m² of the silicone resin thus prepared.

The anchorage of silicone coating on the samples were tested using rub-off test. Anchorage is a term used in the field to describe the attachment of the release coating to the substrate. Rub-off test is for testing the ability to remove, under applied pressure, the silicone release coating from the substrate onto which it is coated. The samples were tested by a manual rub test with a piece of rubber. The silicone adhesion was tested immediately after the siliconization from the formed release liner.

The results are listed in the table below. The adhesion scale is indicated by number 1, 2 and 3. “1” indicates that the silicone withstood strong rubbing without detaching; “2” indicates that the silicone surface was smeared after strong rubbing; “3” indicates that the silicone detached after strong rubbing.

| Sample | rub-off |
|---|---|
| Example E2 | 1 |
| Example E3 | 2 |
| Example E4 | 1 |
| Example C1 | 3 |
| Example C2 | 3 |

1. A polymeric film for a release liner, comprising
a polymeric support layer of a first composition comprising one or more polyolefins and/or polyesters, and
an extruded primer layer of a second composition comprising a thermoplastic polymer covalently bonded to functional vinyl groups.

2. The polymeric film according to claim 1, further comprising a tie layer between the polymeric support layer and the extruded primer layer.

3. A method for manufacturing a polymeric film for a release liner, said method comprising
extruding a molten first composition comprising one or more polyolefins and/or polyesters, thereby obtaining an extruded first composition,
extruding a molten second composition comprising a thermoplastic polymer covalently bonded to functional vinyl groups, thereby obtaining an extruded second composition,
allowing the temperature of the extruded molten first composition to decrease below its melting point, thereby forming a polymeric support layer,
allowing the temperature of the extruded molten second composition to decrease below its melting point, thereby forming an extruded primer layer, and
forming the polymeric film comprising the polymeric support layer and the extruded primer layer.

4. The method according to claim 3, further comprising
extruding a third composition comprising a compatibilizer, thereby obtaining an extruded third composition, and
allowing the temperature of the extruded molten third composition to decrease below its melting point, thereby forming a tie layer,
such that the tie layer is situated between the polymeric support layer and the extruded primer layer.

5. The method according to claim 3, wherein at least two of the molten compositions are co-extruded.

6. The method according to claim 3, wherein the thermoplastic polymer covalently bonded to functional vinyl groups is a reaction product of a molten thermoplastic and a grafting agent containing functional vinyl groups.

7. The method according to claim 3, wherein
the thermoplastic polymer covalently bounded to vinyl groups has been formed from a thermoplastic poly(vinyl alcohol) (PVA).

8. The method according to claim 3, wherein
the thermoplastic polymer covalently bounded to vinyl groups comprises ester bonded pendant chains of which at least some end into vinyl groups, wherein the pendant chains which end into vinyl groups contain a catenated carbon structure of at least 4 carbon atoms.

9. The method according to claim 3, wherein
the second composition further comprises
one or more plasticizers, and/or
non thermoplastic.

10. The method according to claim 3, wherein
the tie layer comprises polyolefin grafted with maleic anhydride, acrylic acid, or glycidyl methacrylate.

11. The method according to claim 3, wherein the extruded primer layer has at least one of the following properties:
the PPS roughness value is less than 1 μm,
the extruded primer layer comprising thermoplastic polymer covalently bound to functional vinyl groups has a coat weight of at least 0.6 g/m²,
the extruded primer layer contains functional vinyl groups in an amount of at least 0.06 mmol/m²,
the thermoplastic polymer contains a vinyl group molality bᵥᵢₙ which is in the range of 0.05 mmol/g to 2.00 mmol/g determined as millimoles per gram of dry thermoplastic polymer, when determined by iodometric titration method following the standard ISO 3961:2009(E).

12. The method according to claim 3, wherein
the polymeric support layer comprises one or more of high density polyethylene (HDPE), polypropylene (PP), polybutylene, polyethylene terephthalate (PET) and PET copolymers, and/or
the polymeric support layer comprises a PET copolymer, said PET copolymer containing cyclohexanedimethanol or isophthalic acid comonomers, and/or
the polymeric support layer comprises a polypropylene, and the tie layer comprises polypropylene grafted with maleic anhydride.

13. (canceled)

14. (canceled)

15. The method according to claim 3, further comprising,
prior to extruding the molten second composition
reacting a molten thermoplastic and a grafting agent containing functional vinyl groups, preferably in a solvent-free reaction, thereby obtaining the second composition being a thermoplastic polymer covalently bounded to functional vinyl groups.

16. The method according to claim 15, wherein
the step of reacting a molten thermoplastic and a grafting agent containing functional vinyl groups comprising:
heating thermoplastic poly(vinyl alcohol) having hydroxyl groups, wherein the thermoplastic poly(vinyl alcohol) has been dried and has a degree of hydrolysis in the range of 65 to 95 mol-%,
and
admixing grafting agent with the thermoplastic poly(vinyl alcohol), wherein said grafting agent is an organic acid anhydride having at least a chain which has a catenated carbon structure of at least 4 carbon atoms and which ends into a vinyl group,
such that a mixture is obtained which contains molten thermoplastic poly(vinyl alcohol) having hydroxyl groups and organic acid anhydride which contains chains which end into vinyl groups, and
mixing the mixture at a temperature which is above the melting point of the mixture, thereby causing a reaction in a melt state, wherein at least some of the organic acid anhydride reacts with the hydroxyl groups of the thermoplastic poly(vinyl alcohol) in an ester bond forming condensation reaction,
such that reaction product, being the second composition, is formed which contains
carboxylic acid residue of the ester bond forming condensation reaction, wherein at least some of said carboxylic acid residue contains chains which end into vinyl groups, and
a thermoplastic poly(vinyl alcohol) derivative which contains ester bonded pendant chains of which at least some end into vinyl groups.

17. A release liner comprising
the polymeric film according to claim 1, and
a silicone coating layer on top of the polymeric film.

18. The polymeric film according to claim 1, wherein the thermoplastic polymer covalently bonded to functional vinyl groups is a reaction product of a molten thermoplastic and a grafting agent containing functional vinyl groups.

19. The polymeric film according to claim 1, wherein the thermoplastic polymer covalently bounded to vinyl groups has been formed from a thermoplastic poly(vinyl alcohol) (PVA).

20. The polymeric film according to claim 1, wherein the thermoplastic polymer covalently bounded to vinyl groups comprises ester bonded pendant chains of which at least some end into vinyl groups, wherein the pendant chains which end into vinyl groups contain a catenated carbon structure of at least 4 carbon atoms.

21. The polymeric film according to claim 1, wherein the second composition further comprises
one or more plasticizers, and/or
non-thermoplastic.

22. The polymeric film according to claim 1, wherein the tie layer comprises polyolefin grafted with maleic anhydride, acrylic acid, or glycidyl methacrylate.

23. The polymeric film according to claim 1, wherein the extruded primer layer has at least one of the following properties:
the PPS roughness value is less than 1 μm,
the extruded primer layer comprising thermoplastic polymer covalently bound to functional vinyl groups has a coat weight of at least 0.6 g/m²,
the extruded primer layer contains functional vinyl groups in an amount of at least 0.06 mmol/m²,
the thermoplastic polymer contains a vinyl group molality bᵥᵢₙ which is in the range of 0.05 mmol/g to 2.00 mmol/g determined as millimoles per gram of dry thermoplastic polymer, when determined by iodometric titration method following the standard ISO 3961:2009(E).

24. The polymeric film according to claim 1, wherein the polymeric support layer comprises
one or more of high density polyethylene, polypropylene, polybutylene, polyethylene terephthalate and PET copolymers, and/or
the polymeric support layer comprises a PET copolymer, said PET copolymer containing cyclohexanedimethanol or isophthalic acid comonomers, and/or
the polymeric support layer comprises a polypropylene, and the tie layer comprises polypropylene grafted with maleic anhydride.
